(19) United States
(12) Patent Application Publication
(10) Pub. No.: US 2016/0190706 A1
(43) Pub. Date: Jun. 30, 2016

(54) ANTENNA MODULE

(71) Applicant: SAMSUNG ELECTRO-MECHANICS CO., LTD., Suwon-Si (KR)

(72) Inventors: Sang Woo BAE, Suwon-Si (KR); Hyun Sam MUN, Suwon-Si (KR)

(73) Assignee: SAMSUNG ELECTRO-MECHANICS CO., LTD., Suwon-Si (KR)

(21) Appl. No.: 14/956,810

(22) Filed: Dec. 2, 2015

(30) Foreign Application Priority Data
Dec. 31, 2014 (KR) 10-2014-0194615

(51) Int. Cl. H01Q 21/00; H01Q 1/52

(52) U.S. Cl. CPC H01Q 21/00; H01Q 21/0087; H01Q 1/526

(57) ABSTRACT

An antenna module including a plurality of antennas, a cable connecting the plurality of antennas, and a fixing member configured to maintain a shape of the cable, wherein the cable has a zigzag shape.

### CROSS-REFERENCE TO RELATED APPLICATION

This application claims the benefit under 35 USC 119(a) of Korean Patent Application No. 10-2014-0194615 filed on Dec. 31, 2014, in the Korean Intellectual Property Office, the entire disclosure of which is incorporated herein by reference for all purposes.

### BACKGROUND

1. Field

The following description relates to an antenna module and a method of connecting antennas.

2. Description of Related Art

In general, an antenna module may include a plurality of antennas. Here, mutual interference may occur between the respective antennas of the plurality of antennas. For example, a television (TV) has an antenna module including a plurality of antennas in order to support various a local area wireless communications such as Wi-Fi, Bluetooth™, and the like. Here, a frequency band of Wi-Fi and a frequency band of Bluetooth™ may overlap with each other, such that mutual interference may occur in the plurality of antennas, respectively. Such mutual interference occurring in the plurality of antennas may be overcome by isolation of the antennas. Thus, a solution for improving antenna isolation is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna module and a method of connecting antennas includes a plurality of antennas configured to radiate signals, a cable connecting the plurality of antennas having a zigzag shape, and fixing members fixing the cable such that a shape of the cable is maintained. The zigzag shape may have a “W” shape. The antenna module may include a cable connecting a plurality of antennas having a grounded outer coating and an isolator connected to the outer coating of the cable.

In another general aspect, a method of connecting antennas includes connecting a plurality of antennas to each other by a cable, fixing the cable to a substrate at predetermined points of the cable with a fixing member such that the cable has a zigzag shape; and disposing an isolator on an outer coating of the cable at a position where a virtual straight line, between the plurality of antennas, crosses the cable.

In another general aspect, a television including an antenna module including a plurality of antennas, a cable connecting two of the plurality of antennas to each other; and an isolator connected to an outer coating of the cable, wherein the outer coating is a ground coating.

Other features and aspects will be apparent from the following detailed description, the drawings, and the claims.

### BRIEF DESCRIPTION OF DRAWINGS

FIGS. 1 through 5 are views illustrating an example of an antenna module;

FIG. 6 is a view illustrating an example of a connection of an isolator illustrated in FIGS. 4 and 5; and

FIG. 7 is a flow chart illustrating an example of a method of connecting antennas.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

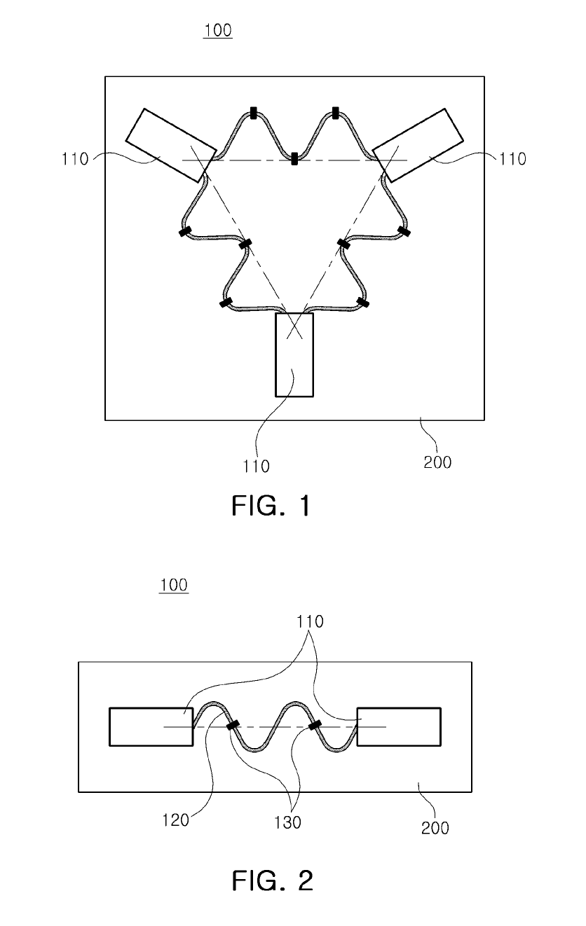

Referring to FIGS. 1 through 5, an antenna module 100 includes a plurality of antennas 110, a cable 120, fixing members 130, and an isolator 140. The plurality of antennas 110 each radiate, or transmit, a signal. For example, the plurality of antennas 110 are each disposed in predetermined positions on a substrate to radiate, wireless communications signals for a TV. Here, the plurality of antennas 110 are two or more antennas. For example, as illustrated in FIG. 1, the plurality of antennas 110 includes three antennas. Here, the antenna module 100 includes three cables 120, connecting the respective antennas 110 to each other, having a zigzag shape.

For example, in a case in which the frequency bands of signals, respectively radiated from the plurality of antennas 110, are overlapped with each other, mutual interference between the plurality of antennas 110 may become severe. Here, the antenna module 100 improves isolation of the antenna module 100 by reducing mutual interference occurring in the plurality of antennas 110.

Referring to FIG. 2, the cable 120 connecting the plurality of antennas 110 to each other, has a zigzag shape. The cable includes at least two ridges having bending directions opposing each other. Therefore, the isolation of the antenna module 100 is improved.

For example, as illustrated in FIG. 3, in a case in which the cable 120 has a “W” shape, the bending direction of a middle ridge is different from the bending directions of the two ridges on either side thereof. In addition, the cable 120 may be have a grounded outer coating at a predetermined point. Here, the outer coating encloses a ground wire by coating the ground wire of the cable 120. The predetermined point includes the ridges of the cable 120. For example, the predetermined point may mean the whole of the cable 120. An outer coating 123 of the cable 120 contacts the isolator 140.

The fixing members 130 fix the cable 120 in order to maintain the shape of the cable 120. For example, in the case in which the cable 120 has a zigzag or “W” shape, the fixing members 130 fix the shape of the cable 120 so that the bending direction of the middle ridge in the cable 120 and the bending directions of the two ridges on either side thereof are unchanged. The fixing members 130 fix the cable 120, such that the isolation of the antenna module 100 is maintained in an improved state. For example, the fixing members 130 may fix the substrate 200 and the predetermined point of the cable 120 to each other by a hook or adhesive tape.

The isolator 140 is connected to the outer coating 123 of the cable 120. For example, the isolator 140 may be formed of a material having a high dielectric constant. Therefore, the isolation of the antenna module 100 may be improved.

For example, as illustrated in FIG. 4, the isolator 140 is disposed on a virtual straight line between the plurality of antennas 110. For example, the virtual straight line, connecting the plurality of antennas 110 to each other, and pass through the isolator 140. Therefore, the isolation of the antenna module 100 may be further improved.

Referring to FIG. 5, the antenna module 100 includes both of the fixing members 130 and the isolator 140. For example, the antenna module 100 maintains the zigzag shape of the cable 120 with the fixing members 130 and includes the isolator 140. Therefore, the isolation of the antenna module 100 may be further improved.

In a case in which the cable 120 of the antenna module 100 does not have the zigzag shape, the isolation may be about −25 dB. In a case in which the cable 120 of the antenna module 100 has the zigzag shape or the isolator 140, the isolation may be about −35 dB. In a case in which the cable 120 of the antenna module 100 has the zigzag shape and the isolator 140, the isolation may be about −42 dB.

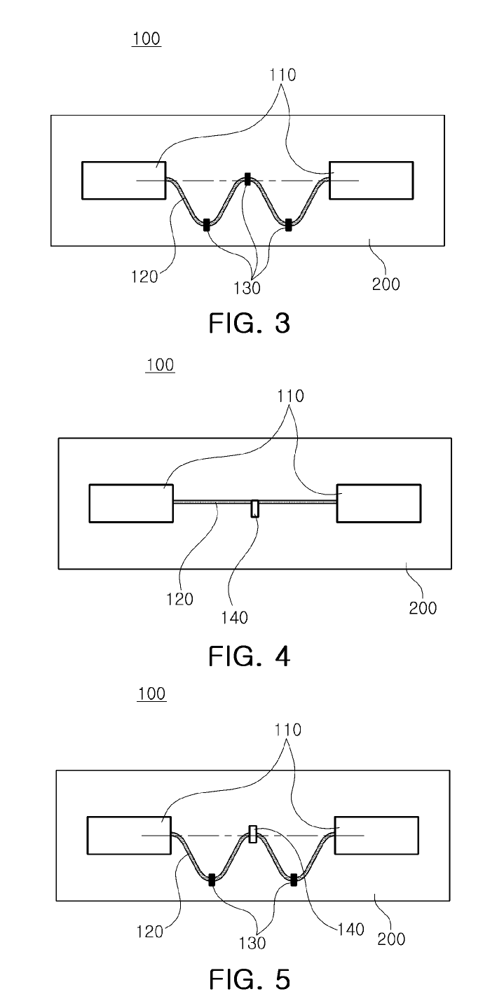

Referring to FIG. 6, the cable 120 includes a signal wire 121, and the ground wire 122 enclosing the signal wire 121. The ground wire 122 is coated with an outer coating 123, enclosing the ground wire 122 and the signal wire 121. A noise signal may pass through the signal wire 121. The isolator 140 is disposed on a surface of the outer coating 123. Therefore, the cable 120 and the isolator 140 are connected to each other. By having the isolator 140 close to the ground wire 122, the isolation of the antenna module is improved.

Hereinafter, a method of connecting antennas will be described. Since the method of connecting the antennas of the antenna module 100 is described above with reference to FIGS. 1 through 6, similar descriptions corresponding to the above-mentioned elements will be omitted here.

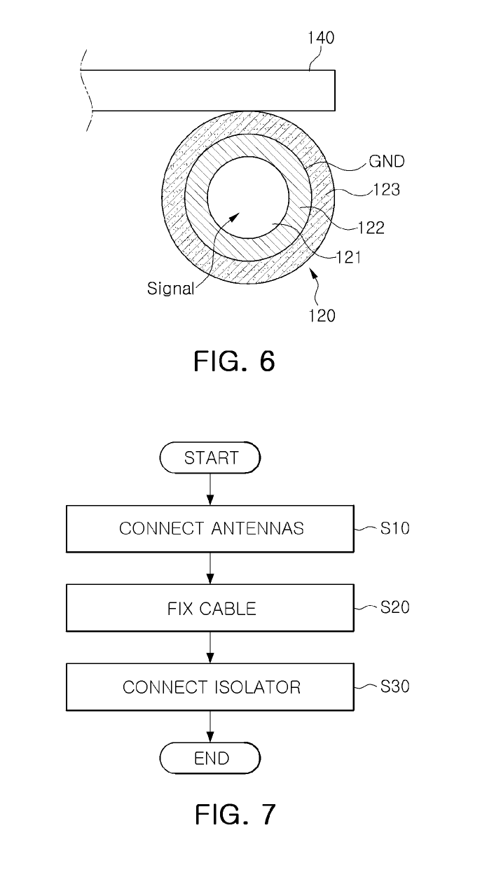

Referring to FIG. 7, the method of connecting antennas includes a connecting operation (S10), a fixing operation (S20), and an isolating operation (S30).

In the connecting operation (S10), a plurality of antennas are connected to each other by a cable.

In the fixing operation (S20), the cable is fixed to a substrate in a predetermined position so that a shape of the cable is maintained.

In the isolating operation (S30), an isolator is connected to an outer coating of the cable at a position wherein a virtual straight line between the two antennas crosses the cable.

The isolation of the antennas, connected using the method described above, may be improved. Thus, an interference phenomenon of the antenna module is reduced, such that wireless communications at the antenna may be smoothly performed. In addition, in a case in which the isolation of the antenna is reduced, a wireless communication specification of the antenna module may be satisfied.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna module comprising:
a plurality of antennas;
a cable connecting the plurality of antennas; and
a fixing member configured to maintain a shape of the cable,
wherein the cable has a zigzag shape.

2. The antenna module of claim 1, wherein the plurality of antennas are respectively disposed on a predetermined position of a substrate, and
the fixing member fixes the cable to the substrate, wherein the fixing member is a hook or adhesive tape.

3. The antenna module of claim 2, wherein the cable has a “W” shape, and
the fixing member comprises a plurality of fixing members configured to fix three ridges of the “W” shape of the cable to the substrate.

4. The antenna module of claim 1, further comprising an isolator connected to the cable,
wherein the cable comprises an outer coating and the isolator is connected to the outer coating.

5. The antenna module of claim 4, wherein the isolator is disposed on a virtual straight line extending between the plurality of antennas, and
the plurality of antennas are configured to radiate, respectively, overlapping frequency bands.

6. An antenna module comprising:
a plurality of antennas;
a cable connecting two of the plurality of antennas to each other; and
an isolator connected to an outer coating of the cable,
wherein the outer coating is a ground coating.

7. The television of claim 6, wherein the plurality of antennas are respectively disposed on a predetermined position of a substrate, and
the plurality of antennas are configured to transmit or receive signals comprising overlapping frequency bands wherein the signals are wireless communication signals.

8. The television of claim 7, wherein the wireless communication signals comprise a local area wireless network.

9. A method of connecting antennas comprising:
connecting a plurality of antennas to each other by a cable;
fixing the cable to a substrate at predetermined points of the cable with a fixing member such that the cable has a zigzag shape; and
disposing an isolator on an outer coating of the cable at a position where a virtual straight line, between the plurality of antennas, crosses the cable.
